(19) United States
(12) Patent Application Publication
(10) Pub. No.: US 2007/0047617 A1
(43) Pub. Date: Mar. 1, 2007

(54) TAP WATER TEMPERATURE MEASUREMENT AND DISPLAY SYSTEM

(75) Inventors: Henry F. Thorne, West View, PA (US); Robert D. Daley, Pittsburgh, PA (US)

Correspondence Address: BLYNN L. SHIDELER;THE BLK LAW GROUP, 3500 BROKKTREE ROAD, SUITE 200, WEXFORD, PA, 15090, US

(73) Assignee: THORLEY INDUSTRIES, LLC, Pittsburgh, PA (US)

(21) Appl. No.: 11/460,991

(22) Filed: Jul. 30, 2006

Related U.S. Application Data
(60) Provisional application No. 60/703,708, filed on Jul. 29, 2005.
(60) Provisional application No. 60/750,279, filed on Dec. 14, 2005.

(51) Int. Cl. G01K 7/00

(52) U.S. Cl. 374/163

(57) ABSTRACT

A tap water temperature display system includes a temperature sensor measuring the tap water temperature. An LCD display will display the tap water temperature as measured by the temperature sensor. Light sources for backlighting the LCD display form at least two distinct backlighting colors and the displayed backlighting color is responsive to the tap water temperature as measured by the temperature sensor. The display has a graphical temperature display, wherein the graphical display includes temperature range indicia indicative of a range of possible water temperatures, acceptable range indicia indicative of a sub-set of the displayed temperature range indicia that is an acceptable tap water temperature, and temperature indicating indicia indicative of the measured tap water temperature. An audible alarm is responsive to the measured tap water temperature and has distinct audible alerts that are indicative of distinct measured tap water temperatures.

### RELATED APPLICATIONS

The present application claims the benefit of provisional patent application Ser. No. 60/703,708 entitled “Safety Bath Spout Cover and Safety Bath Spout” filed Jul. 29, 2005. The present application claims the benefit of provisional patent application Ser. No. 60/750,279 entitled “Secure, Impact Resistant, Tool Free Attaching Bath Spout Cover” filed Dec. 14, 2005.

### BACKGROUND OF THE INVENTION

1. Field of the Invention

The present invention relates to fluid temperature display systems. More particularly the present invention is directed to a tap water temperature display systems with visual and audible components.

2. Background Information

Tap water temperature is an important component for the comfort and safety of the user's of the tap water. For example, bathing in a bathtub or shower, washing hands in a sink generally require water to be dispensed from a faucet within a desired temperature range for the user's comfort and safety. Serious burns can occur where the water temperature is too hot. The concern becomes far more significant for caregivers bathing others such as infants, small children, the elderly, the infirm, and the disabled. Significantly cold tap water temperature can also pose concern for caregivers. There is a need for a tap water temperature measurement display system that effectively and efficiently displays tap water temperature.

The bathroom represents an area of the home having a relatively higher risk of injury and, consequently many products have been designed to help minimize these risks. For example, existing bathtub water spout covers typically designed to prevent impact injuries among user's, such as children, disabled and elderly, associated with bumping against the hard metal faucets or spouts common in bathtubs. The existing spout covers are simply soft plastic sleeves that slide over the existing spout and have an opening that generally aligns with the spout opening. The existing spout covers are often in child friendly shapes, such as the form of a whale. The existing commercially viable spout covers essentially offer little more than impact resistance, when they are left in place, and a child friendly shape (the child friendly configuration can inhibit the safety functions by enticing the child to pull off the spout cover to play with in the bathtub).

As noted above, a significant safety concern with bathing infants and small children is the danger of scalding the baby/child with bath water that is too hot for a baby or young child. The danger of scalding is also present for other bath users, but babies/children are more susceptible to this injury because their skin is thinner and young children are more likely to make a user error when unaccompanied by an adult. Water temperature that is acceptable, even preferable to some adults, is dangerous to babies/young children. Incorporating elements into a bath spout safety cover that addresses these safety issues will greatly increase the utility of the spout cover and the relative safety of the users. Again, any technological solution to this issue incorporated into a bath spout cover must be a cost effective solution for commercial acceptance.

Hand washing in a sink poses similar dangers to small children as bathing with regard to the dangers of scalding. The problem is exacerbated by the facts that a “hot” water temperature is strongly encouraged for the children to use by adults, and hand washing is often an activity that young children are soon granted limited independence in and perform, somewhat, unsupervised. Sinks are also often used in conjunction with a baby bathing tub to bath infants, and the dangers of scalding an infant with excessive tap water temperatures are noted above. Although the health concerns are less immediate and the main issue would be the comfort of the infant, excessively low tap water temperatures would not be desired for bathing infants from a sink spout (or from a bath spout). Consequently there is a need for a tap water temperature measurement display system for a sink faucet or spout that effectively and efficiently displays tap water temperature. Again, any technological solution to these issues incorporated into a sink spout or sink spout attachment must be a cost effective solution for commercial acceptance.

It is the objects of the present invention to address the deficiencies of the prior art bath spout covers discussed above and to do so in an efficient cost effective manner.

### SUMMARY OF THE INVENTION

It is noted that, as used in this specification and the appended claims, the singular forms “a,” “an,” and “the” include plural referents unless expressly and unequivocally limited to one referent.

For the purposes of this specification, unless otherwise indicated, all numbers expressing quantities of ingredients, reaction conditions, and other parameters used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

All numerical ranges herein include all numerical values and ranges of all numerical values within the recited numerical ranges. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

The various embodiments and examples of the present invention as presented herein are understood to be illustrative of the present invention and not restrictive thereof and are non-limiting with respect to the scope of the invention.

Within the meaning of this application the terms “spout” and “faucet” interchangeably refer to a water dispensing plumbing fixture generally extending from the wall, such as in a bathtub essentially at the top surface of the bathtub, or in a shower enclosure from an elevated wall position, or above a sink basin. The term “tap water” within this application references the water dispensed from a plumbing fixture, namely a spout. The term “soft exterior” within the meaning of this application refers to an impact resistant material that is softer, such as measured by a Rockwell Hardness test, than conventional metal (e.g. steel) or hard plastic, and will be understood by those in the child proofing art. A wide variety of materials can be used to form the soft exterior, including rubber, soft plastics (low durometer plastics), foams and the like.

The term backlighting with regard to an LCD display references the lighting of a background portion of the display upon which the characters are displayed.

According to one embodiment of the present invention addressing at least one of the above stated objects, a tap water temperature display system includes a temperature sensor measuring the tap water temperature, a LCD display for displaying at least the tap water temperature as measured by the temperature sensor, and light sources for backlighting of the LCD display, wherein the light sources form at least two distinct backlighting colors and wherein the displayed backlighting color is responsive to at least the tap water temperature as measured by the temperature sensor.

In one particular embodiment of the invention the sensor and display have a thermal time constant of less than 5 seconds between a measured temperature and the display of the temperature. The display may have a graphical temperature display and a distinct alpha-numeric display, and may further include power source for the display system wherein the power source is one of battery power and hydroelectric power. A hydroelectric power source is one that will derive power from water flowing through the associated faucet.

In one particular embodiment of the invention further includes an audible alarm, wherein the temperature sensor is coupled to the audible alarm, wherein the audible alarm is a progressive audible temperature alarm with varied levels of activation corresponding to the severity of the temperature condition sensed. The invention may further include a manual override for disengaging the audible alarm, and wherein the actuation of the manual override is child-proof.

In one particular embodiment of the invention wherein the light sources form at least three distinct backlighting colors, including blue, white and red. The blue backlighting color is indicative of a tap water temperature as measured by the temperature sensor lower than a lower preset threshold, the red backlighting color is indicative of a tap water temperature as measured by the temperature sensor higher than a higher preset threshold, and the white backlighting color is indicative of a tap water temperature as measured by the temperature sensor between the lower preset threshold and the higher preset threshold.

One embodiment of the invention provides a tap water temperature display system including a temperature sensor measuring the tap water temperature; and a digital display for displaying at least the tap water temperature as measured by the temperature sensor having at least a graphical temperature display, wherein the graphical display includes (i) temperature range indicia indicative of a range of possible water temperatures, (ii) acceptable range indicia indicative of a sub-set of the displayed temperature range indicia that is an acceptable tap water temperature, and (iii) temperature indicating indicia indicative of the tap water temperature as measured by the temperature sensor. The acceptable range indicia may include bounding indicia indicative of the upper and lower limits of the sub-set of displayed temperature range indicia and explanatory text indicative of the acceptable range. The temperature indicating indicia may be a highlighted temperature range indicia. The display system may further include an alpha-numeric display for displaying the at least the tap water temperature as measured by the temperature sensor, and wherein the alpha-numeric display is distinct from the graphical display.

The display of the invention may further comprising a water activation alarm indicating unauthorized use and a water activation alarm deactivation mechanism allowing for authorized use.

These and other advantages of the present invention will be clarified in the description of the preferred embodiments taken together with the attached figures.

### BRIEF DESCRIPTION OF THE DRAWINGS

FIG. 1 is a perspective top view of a safety bath spout cover incorporating a display according to one embodiment of the present invention;

FIG. 2 is a schematic side elevation view of the safety spout cover of FIG. 1;

FIG. 3 is a schematic front elevation view of the safety spout cover of FIG. 1;

FIG. 4 is a perspective top view of a safety bath spout cover with a display according to a second embodiment of the present invention;

FIG. 5 is a schematic side elevation view of the safety spout cover of FIG. 4;

FIG. 6 is a schematic front elevation view of the safety spout cover of FIG. 4;

FIG. 7 is a schematic sectional view of a water guide for the spout cover according to one embodiment of the present invention;

FIG. 8 is a plan view of a sensor array in accordance with one aspect of the present invention;

FIG. 9 is a schematic view of a closing mechanism for the spout cover according to one embodiment of the present invention;

FIG. 10 is a schematic elevation view of a spout with a display according to one embodiment of the present invention;

FIG. 11 is a schematic flow chart of the microprocessor operation of the display associated with the spout cover and the spout in accordance with the present invention;

FIG. 12 is a perspective view of a bath spout cover with a display in accordance with another embodiment of the present invention;

FIG. 13 is a side perspective view of the spout cover and display of FIG. 12; and

FIG. 14 is a perspective view of a bath spout cover with a display in accordance with another embodiment of the present invention.

### DESCRIPTION OF THE PREFERRED EMBODIMENTS

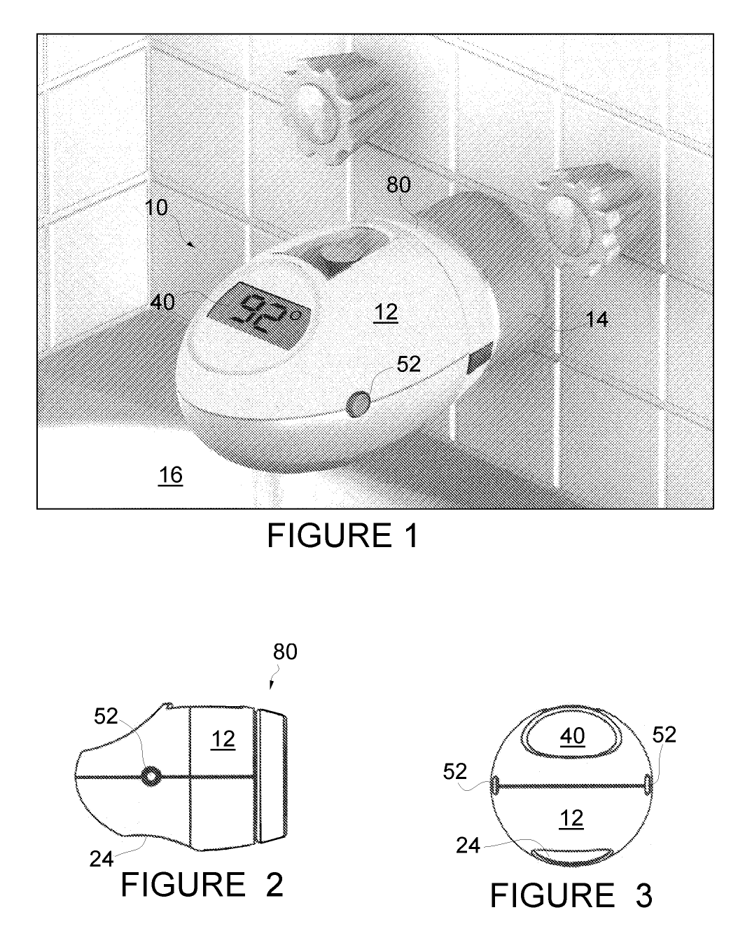

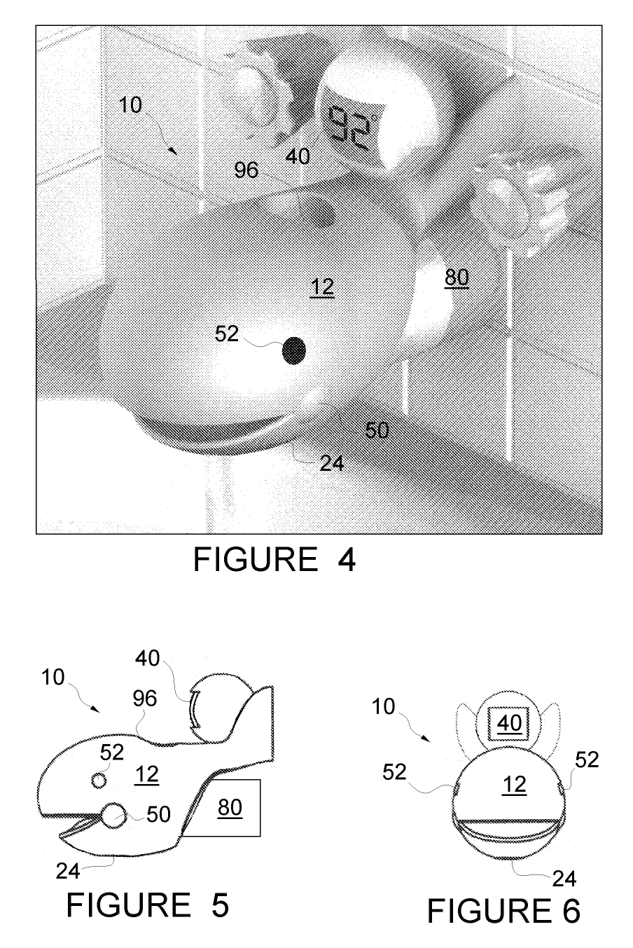

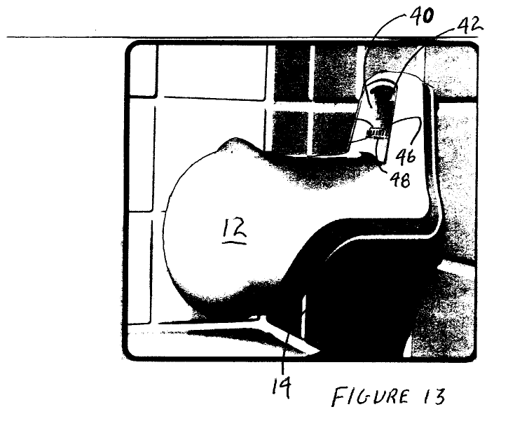

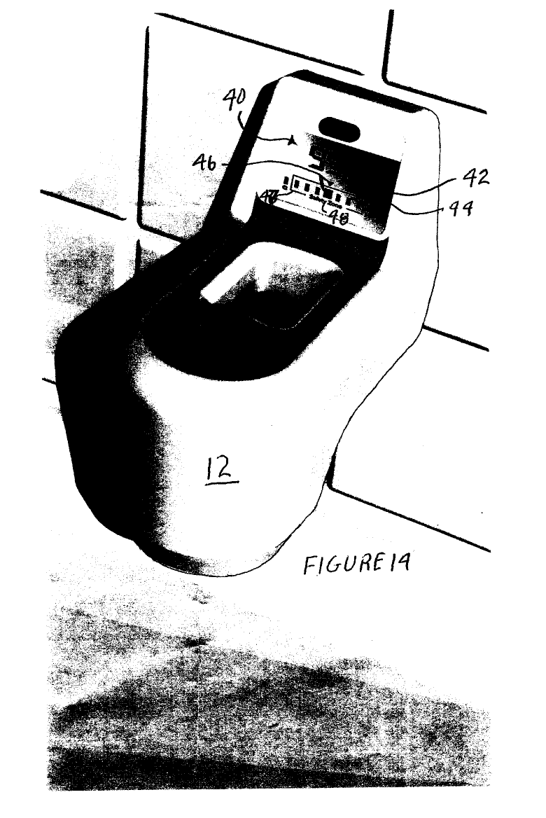

FIGS. 1-3 illustrates one embodiment of the safety bath spout cover 10 incorporating a display 40 according to the present invention, FIGS. 4-6 illustrate a distinct second embodiment of the safety bath spout cover 10 with a display 40 according to the present invention, FIGS. 12-13 illustrate a distinct further embodiment of the safety bath spout cover 10 with a modified display 40 according to the present invention; and FIG. 14 illustrates a another distinct embodiment of the safety bath spout cover 10 with a display 40 according to the present invention.

The safety bathtub spout cover 10 includes a hollow body 12 having a soft exterior for impact resistance and user safety. As discussed above, the term “soft exterior” within the meaning of this application refers to an impact resistant material that is softer than conventional metal or hard plastic, and will be understood by those in the child proofing art. A wide variety of materials can be used to form the soft exterior, including rubber, soft plastics (low durometer plastics), foams and the like. The exterior of the body 12 can have any desired shape, including child friendly animal shapes as shown in FIGS. 4-6. The body 12 is preferably a molded one or two piece assembly, for ease of manufacturing. The term hollow merely means that it can receive a spout 14 therein, for example a three sided “L” shaped structure with a channel receiving the spout is a hollow body 12 within the meaning of this application.

The body 12 of the spout cover 10 is adapted to receive the spout or faucet 14 for a bathtub 16 therein as known in the art. As noted above, the terms “spout” and “faucet” 14 are used herein interchangeably to refer to a water dispensing plumbing fixture as shown in FIGS. 1 and 4. The term spout within this application does encompass sink faucets and shower heads, hover such spouts have little need for a spout cover 10 for impact resistance and therefore these spouts do not present similar safety concerns.

The hollow body 12 may include a water guide 20 formed therein. FIG. 7 is a schematic sectional view of a water guide 20 for the spout cover 10 according to one embodiment of the present invention, wherein the hollow body 12 is removed for clarity. The water guide 20 has a water inlet 22 adapted to receive water from an outlet of the faucet 14 and terminating in a water outlet 24 for the spout cover. The water inlet 22 may be a funnel shape to accommodate inaccuracy in placement by the user as well as variation in the spout 14 outlets between distinct models of faucets 14. The water guide 20 may further include an offset 26 in the flow path to provide an area 28 in the water guide 20 where water is certain to be present when water is flowing from the faucet 14.

A temperature sensor mechanism 30 is positioned within the water flow within the hollow body 12. The sensor mechanism 30 is part of a rapid temperature response for the spout cover 10. The term “rapid” refers to the problem that many temperature measuring devices (e.g. mercury thermometers) have a large lag between the actual temperature changing and the reporting of that change. In this case, where the person is adjusting the water temperature with the faucet handles and wanted to adjust according the temperature displayed (as discussed below), such long lags would be unacceptable. A rapid response in accordance with the present invention is a response between change in temperature of the water and ultimate display to the user on the order of a second or less.

The temperature sensor mechanism 30 will be part of a digital system for rapid response and can be formed as one or more standard thermistors. The thermistor(s) of the sensor mechanism 30 may be coupled to an A/D converter which would be coupled to a BCD converter that drives the digital LCD display (described later). This would allow for no microprocessor, however, the A/D converter cost is greater than the microcontroller with the A/D converter in it. Consequently the thermistor(s) of the sensor mechanism 30 may be coupled to a microprocessor which drives the digital display. Appropriate thermistors can be provided by Digikey.

The temperature sensor mechanism 30 may be placed within the water flow through positioning the temperature sensor mechanism 30 within the water guide 20 of the hollow body 12 in a position offset in plan view from the water inlet 22. Specifically the temperature sensor mechanism 30 would be placed at the end of the offset 26 adjacent area 28 as shown in FIG. 7. As the inlet 22 is shaped as a funnel, as shown in FIG. 7, offset in plan view will mean offset from the exit of the funnel forming the inlet 22. Other shapes for the water guide are, of course possible, as FIG. 7 is intended only as a representation. For example, the outlet 24 could coincide with area 28. Although space considerations suggest that the rearward offset (toward the tub wall beneath the faucet 14), the offset 26 could extend laterally or forward of the inlet 22 and the faucet 14. The water guide 20 may be formed in a more compact structure, provided it does not restrict water flow through the spout cover 10. The water guide 20 may be formed integral with the body 12 or as a separate component contained within the body 12. As an alternative, the water guide 20 may simply be an downwardly extending extension arm with the sensor mechanism 30 at the end. With this configuration even if the arm of the water guide extends beyond the flow of water from the spout 14, water will impinge upon the arm and flow down the arm sufficiently to obtain a signal of the water temperature. With this configuration the arm may include a channel to collect and direct sufficient water for sensor 30 to measure where the sensor 30 is not directly in the water flow.

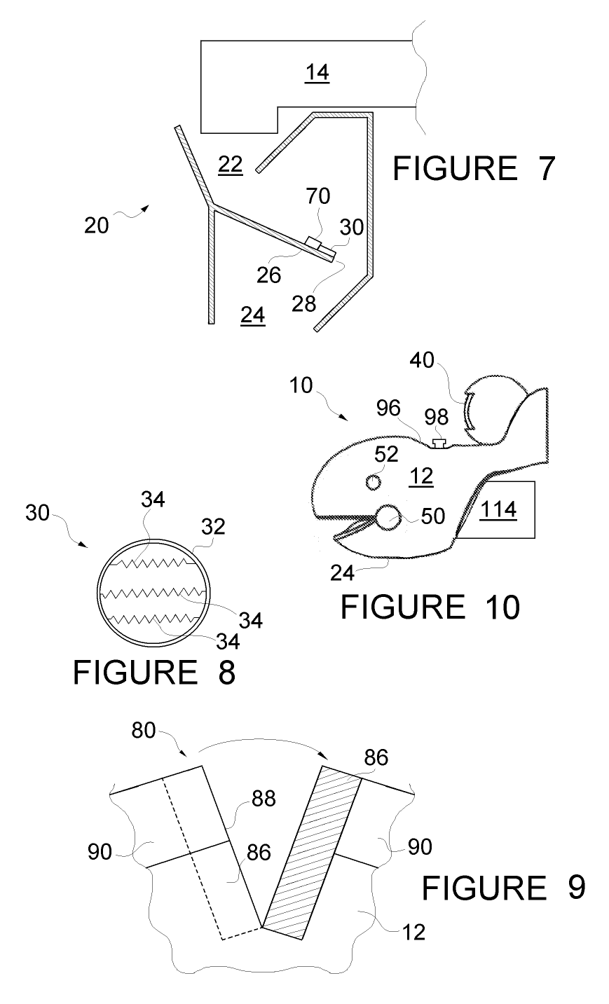

Alternatively, the temperature sensor mechanism 30 may be placed within the water flow through forming of the temperature sensor mechanism 30 as shown in FIG. 8 as a holder 32 having an array of sensors 34, wherein the holder 32 is positioned in the outlet 24 of the water guide 20 such that the sensors 34 that extend across the outlet 24. In this arrangement the outlet 24 of the water guide can coincide with the end of the funnel or inlet 22 and the offset 26 and area 28 eliminated. The sensor array assures that one of the sensors 34 is in the water stream, and the controller will need to need to account for which signal is from the sensor in the water stream and therefore indicative of water temperature.

The temperature sensor mechanism 30 is coupled through a controller (not shown) to a digital temperature display 40, such as a backlit LCD numeric display, on the hollow body 12 for displaying the temperature of the water sensed by temperature sensor mechanism 30. The display, such as digital display 40, is preferably an electronic display for consumer confidence reasons. Analog gauges displaying temperature (E.g. a mercury thermometer, or a kitchen meat thermometer) do not imply the accuracy that people expect and want as compared to an electronic display. In safety products, public perception is important for acceptance and adoption, since when not used a safety product offers little safety. Consequently the display 40 for the spout cover 10 should be an electronic display, either alphanumeric or graphical, such as digital temperature display 40.

The digital display 40 is mounted in a direction facing the tub and at an angle of at least five degrees, more preferably at least 10, relative to vertical, whereby the display 40 is visible from any viewing height above the faucet 14. This allows the parent to view the water condition while standing beside the tub 16. This feature can be beneficial for elderly patients who can see the water temperature indication of the display 40 from a standing position prior to stepping into the tub 16. The display 40 may also be a curved display 40 as shown in FIGS. 4-5. The upper portion of the display has an average angle of at least five degrees, more preferably at least ten degrees, relative to vertical, whereby the display 40 is again, visible from any viewing height above the faucet 14. The display preferably includes an alpha-numeric display 42 of the sensed temperature. The alpha-numeric display is preferably a numerical representation with temperature shown in 1/10^{th} of a degree increments. Of course the display can be in Fahrenheit or Celsius, as desired. The system can include a toggle to switch the desired display.

In addition, the display 40 may be moveable to be positioned by the user to place it in the easiest viewable position, however such movement accommodating systems may add considerable to the cost of the spout cover 10. The forward facing, slightly upward angled positioning of the display 40 is preferred from a cost perspective.

Further, the display 40 may include a visual, non-numeric display of the sensed temperature. Specifically, one non-numeric display is that the display 40 includes back lighting of distinct colors, namely a tri-color system. A blue back lighting would indicate a cool or cold water temperature (relative to taking children taking baths) wherein the temperature is below a preset threshold, a white or normal back lighting would indicate a normal temperature range for children's bath water wherein the sensed water temperature is between a lower and higher preset threshold, and a red back lighting would indicate a dangerous condition for children's bath water wherein the sensed temperature of the tap water is above an upper preset threshold. The back lighting provides an independent non-numeric display for rapidly conveying the sensed condition to the user, effectively acting as a visual alarm. Another modification of the backlighting is to use tri-colored numeric displays for the measured temperature number 42 rather than an associated back lighting. However the described backlighting is believed to better convey the information effectively to the user.

The display 40, in the embodiments of the cover 10 shown in FIGS. 12-14, illustrates a further non-alphanumeric display of the temperature. This display is a graphical display that is separate and distinct from the alpha-numeric display 42. The graphical display includes an array or graph of temperature range indicia 44 that are indicative of a range of possible water temperatures; acceptable range indicia indicative of a sub-set of the displayed temperature range indicia 44 that is an acceptable tap water temperature, and temperature indicating indicia 46 indicative of the tap water temperature as measured by the temperature sensor 30. The acceptable range indicia includes bounding indicia 47 indicative of the upper and lower limits of the sub-set of displayed temperature range indicia 44 (namely a box around the desired sub-set) and explanatory text 48, such as “safety zone” or “comfort zone” or the like, that is indicative of the acceptable range to assist in conveying the meaning of the graphical display. The temperature indicating indicia 48 is, effectively a highlighted or differentiated temperature range indicia 44. In many applications the graphical representation can better convey the meaning of the indicated temperature. The breadth of the acceptable range indicia (e.g. the upper and lower sensed tap water temperature limits of the defined and illustrated “safety zone”) will be preset and can change depending upon what the display 40 is incorporated into. For the bath spout 10 the upper limit is likely defined by an upper or “scalding” water temperature that is unsafe for bathing infants and or small children, while the lower limit is likely defined by a low water temperature that is uncomfortable and/or unsafe for bathing infants and or small children

The non-numeric aspects of the digital display 40 are intended to work in conjunction with the more conventional numeric display features of the display 40, e.g. the back lighting of the display will back light a numeric display.

The temperature sensor mechanism 30 is coupled through the controller to an audible temperature alarm 50 on the hollow body 12, wherein the audible temperature alarm is configured to audibly signal unsafe temperature conditions sensed by the temperature sensor mechanism 30. As discussed above, the temperature sensor mechanism 30 the audible alarm 50 and the temperature display 40 forms a rapid response system having a lag time of less than 1 second between a measured temperature and the display and or alarm, if appropriate. The audible alarm 50 is a progressive audible temperature alarm with varied levels of activation corresponding to the severity of the scald or high temperature condition sensed by mechanism 30. Essentially as the sensed condition becomes more dangerous the audible alarm increases in volume, pitch, frequency or the like.

The specifics of the audible alarm and the variations in possible warning signals to be used are well known to those in the safety art. Any audible warning signal can be used. Further when used in conjunction with the display 40 the audible alarm 50 need only alert the user to the general presence of dangerous conditions while the display will specify the details (e.g. the water temperature is 107 degrees Fahrenheit).

Another aspect of the present invention includes a manual override 52 for disengaging the audible alarm 50, and wherein the actuation of the manual override is child-proof. Specifically the manual override is a pair of buttons 52 on opposed sides of the body 50 that are too far for children to grasp with a single hand. The buttons 52 are pressed simultaneously to actuate the override. This allows adults, e.g. the parents, to take a hot bath that may be at a temperature that would be considered dangerous for children, without hearing the audible alarm 50 which would be distracting and counter productive to the purpose of the relaxing hot bath. The override mechanism 52 must be child-proof so small children could not inadvertently disengage this safety feature. Without the manual override 52 the users would need to take off the spout cover 10 for disengagement of the safety features. Other child safety arrangements for the override could also be used, such as a “depress and twist” motion, which is difficult for children. More elaborate child proofing measures are possible, such as keypads, or pressing in a complex pattern on the buttons 52, but the system should be relatively easy to operate for the adults without greatly increasing the cost or complexity of the cover 10.

In one aspect of the present invention the temperature sensor mechanism 30 and the associated components (e.g. the alarm and display 40) are actuated upon the flow of water through the spout cover 10. This will allow for a long battery life and avoids the need for an always on condition or the need for a separate on switch that could limit the safety effectiveness of the spout cover. The water activation may be through a circuit that is closed in the presence of water, such as through a switch 70 positioned on the offset 26 shown in FIG. 7. Any water activation technique could be utilized, subject to cost considerations. As an alternative to battery power the cover 10 may utilize the flowing water in the spout 14 to generate the power, thereby using a hydro-electric power system.

Another embodiment of the present invention further includes a water activation alarm (which can be the same as audible alarm 50 above) indicating unauthorized use of the spout cover 10 and a child-proof water activation alarm deactivation mechanism allowing for authorized use of the spout cover 10. In this manner parents can be warned of unauthorized or unsupervised bathtub use. The water activation alarm deactivation mechanism can be through buttons 52, if desired. In this arrangement, one use of the buttons would deactivate the water activation alarm, and a second, presumably more complex actuation would deactivate the temperature alarm. Of course, separate child-proof controls may also be provided.

The spout cover 10 includes a closing mechanism 80 for attaching the spout cover 10 to the faucet 14 in a temporary, non-marring, non-residue attachment manner. The closing mechanism 80 may be a releasable band 82 and associated closing buckle 84 as shown in FIGS. 1 and 3, such as found in ski boots and roller blades. Alternatively, the closing mechanism 80 may be overlaying hook and loop type fasteners 86 as shown in FIG. 9. The body 12, in either embodiment of the closing mechanism, may include a slit 88 on an end receiving the faucet 14. Specifically, a strip of hook elements would be attached to the body 12 adjacent the slit 88 in an inward, or outward facing direction, and a strip of the loop elements would be adjacent the slit 88 on the other side and facing the opposite direction. Further, in either embodiment of the closing mechanism an interior faucet facing band 90 of a high friction material (e.g. a soft rubber material) is included to assist in forming the attachment mechanism. The high friction material 90 will be clamped against the faucet 14, making the installed spout cover difficult to slide off (without disengaging the closing mechanism 80. The closing mechanism is not limited to the two disclosed embodiments and could be a variety of devices, such as a simple encircling strap and buckle, as common in backpacks.

Another aspect of the present safety bathtub spout cover includes a recessed access 96 in the body 12 to allow for access to and operation of a push-pull type shower diverter 98 in the faucet 14. This allows the shower to be utilized without removing the spout cover 10, while not jeopardizing the impact resistance of the cover 10. In another aspect according to the present invention the body 12 includes at least one anti-microbial agent.

Further, the features of the safety spout cover 10 with display 40 discussed above may be incorporated directly into a safety spout 100, wherein the safety bathtub spout comprises a hollow body 12 having a soft exterior having a water outlet 24 for the spout 100, a temperature sensor mechanism 30 positioned within the water flow within the hollow body 12, a temperature display 40 coupled to the temperature sensor mechanism 30 for displaying the temperature of the water sensed by temperature sensor mechanism 30, wherein the display 40 is mounted into be visible from any viewing height above the faucet 100, an audible temperature alarm 50 on the hollow body 12 coupled to the temperature sensor mechanism 30, wherein the audible temperature alarm 40 is configured to signal unsafe temperature conditions sensed by the temperature sensor mechanism 30, and a child-proof manual override 52 for disengaging the audible alarm 50. The safety spout 100 does not require a separate water guide, or attachment mechanism to couple the device to a faucet, of course. The safety spout 100 will include a plumbing coupling 114 to attaché the spout 100 to the plumbing from the wall, as is known in the art.

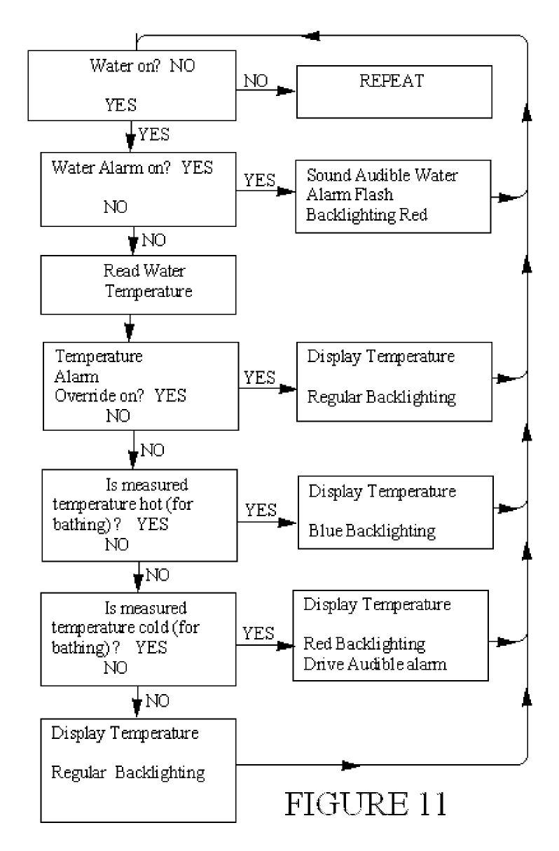

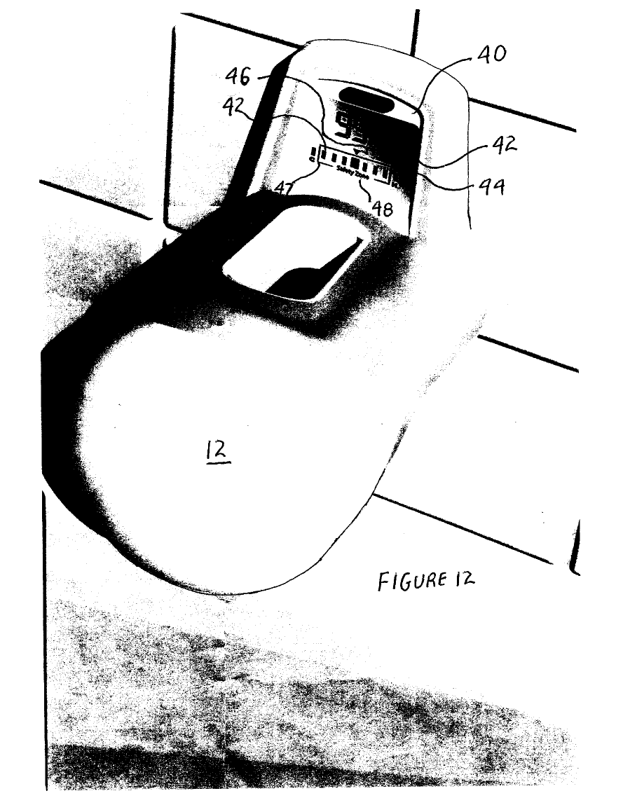

FIG. 11 is a schematic flow chart of the microprocessor operation of the spout cover 10 and the spout 100 with display 40 in accordance with the present invention incorporating all of the above features. Obviously a spout cover 10 according to the present invention can omit several of the detailed features of the illustrated embodiments. The first step is to determine if the water is on, such as from the circuit with switch 70. If the water is not on, the control process is done, the components remain dormant until water is sensed. If the water is found to be on the controller checks if the water alarm for the cover 10 is actuated or not. If the water alarm is on, then the controller will activate the audible water alarm (i.e. the same alarm 50 used for temperature warnings). Additionally the red backlighting for the display 40 can be flashed as a visual warning to the user. Preferably the temperature is not displayed numerically to provide the user with a distinction in the operation (e.g. a flashing red light, no temperature reading and audible alarm is the water alarm). A distinct audible alarm can be used as well, to distinguish the sound from the temperature alarm. If the water alarm is not on (e.g. been deactivated by an authorized user) then the water temperature is read and the system checks for a temperature alarm deactivation (e.g. the parent is or could desire to take a very hot bath). If the temperature alarm is deactivated the temperature is displayed on display 40 with no backlighting (hot water will show the hot temperature on the display 40 without the audible alarm or the visual red backlighting). The temperature alarm override will reset to not being overridden every time the water is turned on (e.g. default for the temperature alarm is on). Where the temperature alarm is still on the temperature alarm, display and backlighting will be actuated in accordance with the temperature. Cold bath water temperatures will be displayed with blue backlighting, normal with no backlighting, and hot with red backlighting and the progressive audible alarm. The process is repeated as the temperature changes.

The spout 10 is only one illustrative representation of the use of the display 40 according to the present invention. The display 40 (with alarm 50) can be similarly incorporated into other spout applications. For example, in sink spouts and shower heads impact resistance is generally not a significant concern such that a device with sensor 30 and display 40 can be attached directly to the end of the faucet (e.g. threaded onto a diverter assembly). Another tap water application is to incorporate the sensor 30 and display 40 (and alarm 50) into a baby bathing tub, wherein the sensor is placed in a location within the stream or flow of tap water. A “foot bath” product in which users fill a basin with generally hot tap water and the basin is configured to receive the user's feet is another anticipated use of the display 40, sensor 30 and alarm 50. The various applications of the display 40 as a tap water temperature measurement display is not intended to be limited in this disclosure.

Whereas particular embodiments of this invention have been described above for purposes of illustration, it will be evident to those skilled in the art that numerous variations of the details of the present invention may be made without departing from the invention as defined in the appended claims. The scope of the present invention is intended to be defined by the appended claims and equivalents thereto.

What is claimed is:

1. A tap water temperature display system comprising:
A temperature sensor measuring the tap water temperature;
An LCD display for displaying at least the tap water temperature as measured by the temperature sensor; and
Light sources for backlighting of the LCD display, wherein the light sources form at least two distinct backlighting colors and wherein the displayed backlighting color is responsive to at least the tap water temperature as measured by the temperature sensor.

2. The temperature display system according to claim 1 wherein the sensor and display have a thermal time constant of less than 5 seconds between a measured temperature and the display of the temperature.

3. The temperature display system according to claim 1 wherein the display has a graphical temperature display and a distinct alpha-numeric display, and further including power source for the display system wherein the power source is one of battery power and hydroelectric power.

4. The temperature display system according to claim 1 further including an audible alarm, wherein the temperature sensor is coupled to the audible alarm, wherein the audible alarm is a progressive audible temperature alarm with varied levels of activation corresponding to the severity of the temperature condition sensed.

5. The temperature display system according to claim 1 wherein the light sources form at least three distinct backlighting colors, including blue, white and red.

6. The temperature display system according to claim 5 wherein the blue backlighting color is indicative of a tap water temperature as measured by the temperature sensor lower than a lower preset threshold, the red backlighting color is indicative of a tap water temperature as measured by the temperature sensor higher than a higher preset threshold, and the white backlighting color is indicative of a tap water temperature as measured by the temperature sensor between the lower preset threshold and the higher preset threshold.

7. The temperature display system according to claim 1 further including an audible alarm, wherein the temperature sensor is coupled to the audible alarm, and further including a manual override for disengaging the audible alarm, and wherein the actuation of the manual override is child-proof.

8. The temperature display system according to claim 1 wherein the display has at least a graphical temperature display, wherein the graphical display includes
(i) temperature range indicia indicative of a range of possible water temperatures,
(ii) acceptable range indicia indicative of a sub-set of the displayed temperature range indicia that is an acceptable tap water temperature, and
(iii) temperature indicating indicia indicative of the tap water temperature as measured by the temperature sensor.

9. A tap water temperature display system comprising:
A temperature sensor measuring the tap water temperature; and
A digital display for displaying at least the tap water temperature as measured by the temperature sensor having at least a graphical temperature display, wherein the graphical display includes
(i) temperature range indicia indicative of a range of possible water temperatures,
(ii) acceptable range indicia indicative of a sub-set of the displayed temperature range indicia that is an acceptable tap water temperature, and
(iii) temperature indicating indicia indicative of the tap water temperature as measured by the temperature sensor.

10. The tap water temperature display system according to claim 9 wherein the acceptable range indicia includes bounding indicia indicative of the upper and lower limits of the sub-set of displayed temperature range indicia and explanatory text indicative of the acceptable range.

11. The tap water temperature display system according to claim 10 wherein the temperature indicating indicia is a highlighted temperature range indicia.

12. The tap water temperature display system according to claim 9 further including an alpha-numeric display for displaying the at least the tap water temperature as measured by the temperature sensor, and wherein the alpha-numeric display is distinct from the graphical display.

13. The tap water temperature display system according to claim 9 further comprising an audible alarm configured to signal unsafe temperature conditions sensed by the temperature sensor and wherein the audible alarm is a progressive audible temperature alarm with varied levels of activation corresponding to the severity of the temperature condition sensed.

14. The tap water temperature display system according to claim 9 further comprising a water activation alarm indicating unauthorized use and a water activation alarm deactivation mechanism allowing for authorized use.

15. The tap water temperature display system according to claim 9 further including light sources for backlighting of the display, wherein the light sources form at least two distinct backlighting colors and wherein the displayed backlighting color is responsive to at least the tap water temperature as measured by the temperature sensor.

16. A tap water temperature display system comprising:
A temperature sensor measuring the tap water temperature;
A display for displaying at least the tap water temperature as measured by the temperature sensor;
An audible alarm responsive at least to the tap water temperature as measured by the temperature sensor and having distinct audible alerts that are indicative of distinct tap water temperatures as measured by the temperature sensor.

17. The tap water temperature display system according to claim 16 wherein the audible alarm is a progressive audible temperature alarm with varied levels of activation corresponding to the severity of the temperature condition sensed.

18. The tap water temperature display system according to claim 16 and further including a manual override for disengaging the audible alarm, and wherein the actuation of the manual override is child-proof.

19. The tap water temperature display system according to claim 16 further including light sources for backlighting of the display, wherein the light sources form at least two distinct backlighting colors and wherein the displayed backlighting color is responsive to at least the tap water temperature as measured by the temperature sensor.

20. The temperature display system according to claim 16 wherein the display has an alpha numeric display and a distinct graphical temperature display, wherein the graphical display includes
(i) temperature range indicia indicative of a range of possible water temperatures,
(ii) acceptable range indicia indicative of a sub-set of the displayed temperature range indicia that is an acceptable tap water temperature, and
(iii) temperature indicating indicia indicative of the tap water temperature as measured by the temperature sensor.
